(19) United States
(12) Patent Application Publication
(10) Pub. No.: US 2023/0302821 A1
(43) Pub. Date: Sep. 28, 2023

(54) PRINTING SYSTEM

(71) Applicant: TOSHIBA TEC KABUSHIKI KAISHA, Tokyo (JP)

(72) Inventor: Daisuke Ishikawa, Mishima Shizuoka (JP)

(21) Appl. No.: 17/972,687

(22) Filed: Oct. 25, 2022

(30) Foreign Application Priority Data
Feb. 8, 2022 (JP) 2022-018097

(51) Int. Cl. B41J 3/407; B41J 11/00; G06F 40/109; G06K 15/02

(52) U.S. Cl. CPC B41J 3/4075; B41J 11/008; G06F 40/109; G06K 15/1802; G06K 15/1825; B41J 2203/01; G06K 2215/0097

(57) ABSTRACT

According to one embodiment, a control unit of a printing system determines a printing region on an object to be printed being conveyed by a conveyance machine, the printing region being provided to be printed any write information therein as printing information, determines whether or not the printing information having a specified character size can be printed in the printing region, and performs adjustment of a printing format of the printing information, the adjustment including at least changing the character size, so that the printing information can be printed in the printing region when determining that the printing information cannot be printed in the printing region. A printing unit prints the printing information having the adjusted printing format in the printing region of the object to be printed according to a timing at which the printing region of the object to be printed being conveyed by the conveyance machine passes through the printing unit.

### CROSS-REFERENCE TO RELATED APPLICATION

This application is based upon and claims the benefit of priority from Japanese Patent Application No. 2022-018097, filed on Feb. 8, 2022, the entire contents of which are incorporated herein by reference.

### FIELD

Embodiments described herein relate generally to a printing system.

### BACKGROUND

For example, there is a situation in which objects to be printed such as a corrugated cardboard and a returnable box are conveyed one after another on a factory line, and printing information such as a destination is required to be printed on the objects to be printed. In this situation as well, it may be required to reuse an object to be printed from a viewpoint of resource saving.

In the case in which objects to be printed are reused, the sizes of printing regions of objects to be printed that are conveyed one after another are not uniform. The printing region may be a surface of the object to be printed itself or may be a label attached to the object to be printed. If the sizes of printing regions are not uniform and certain printing information is intended to be printed in a printing region of a certain object to be printed, the size of the printing region may not be a size in which the printing information can be printed.

As described above, if printing information is printed with the number of lines and character sizes set in advance in printing regions having various sizes, the printing information may not be accurately printed in the printing regions, and as such, the printing information may not be accurately recorded therein.

### DESCRIPTION OF THE DRAWINGS

FIG. 1 is a perspective view showing a configuration example of a printing system according to a first embodiment;

FIG. 2 is a diagram showing examples of various objects to be printed which are to be used;

FIG. 3 is a schematic diagram showing a pre-operation state of a pressing plate configured to press the object to be printed;

FIG. 4 is a schematic diagram showing a post-operation state of the pressing plate;

FIG. 5 is a schematic diagram showing a positional relationship between the object to be printed and a printer;

FIG. 6 is a block diagram showing an electrical configuration of the printing system;

FIG. 7 is a diagram showing an example of information related to write information stored in a temporary storage unit in FIG. 6;

FIG. 8 is a diagram showing an example of information stored in a printing region table in FIG. 6;

FIG. 9 is a diagram showing an example of object information stored in a database in FIG. 6;

FIG. 10 is a flowchart showing an example of control operation of a control unit in FIG. 6;

FIG. 11 is a flowchart showing the details of a printing setting process in FIG. 10;

FIG. 12 is a flowchart showing the details of printing format adjustment in FIG. 11;

FIG. 13 is a diagram showing examples of printing on labels having various sizes;

FIG. 14 is a diagram showing examples of printing on boxes having various sizes;

FIG. 15 is a diagram showing an example of information related to write information stored in a temporary storage unit in a second embodiment; and

FIG. 16 is a schematic diagram showing the position and posture adjustment operation of the printer in order to cause the object to be printed to face a printer head.

### DETAILED DESCRIPTION

An aspect of exemplary embodiments herein is to provide a printing system capable of accurately recording printing information in printing regions of objects to be printed that are conveyed one after another.

In general, according to one embodiment, a printing system includes a conveyance machine, a control unit, and a printing unit. The conveyance machine conveys the object to be printed. The control unit determines a printing region on the object to be printed being conveyed by the conveyance machine, the printing region being provided to be printed any write information therein as printing information, determines whether or not the printing information having a specified character size can be printed in the printing region, and performs adjustment of a printing format of the printing information, the adjustment including at least changing the character size, so that the printing information can be printed in the printing region when determining that the printing information cannot be printed in the printing region. The printing unit prints the printing information having the adjusted printing format in the printing region of the object to be printed according to a timing at which the printing region of the object to be printed being conveyed by the conveyance machine passes through the printing unit.

### First Embodiment

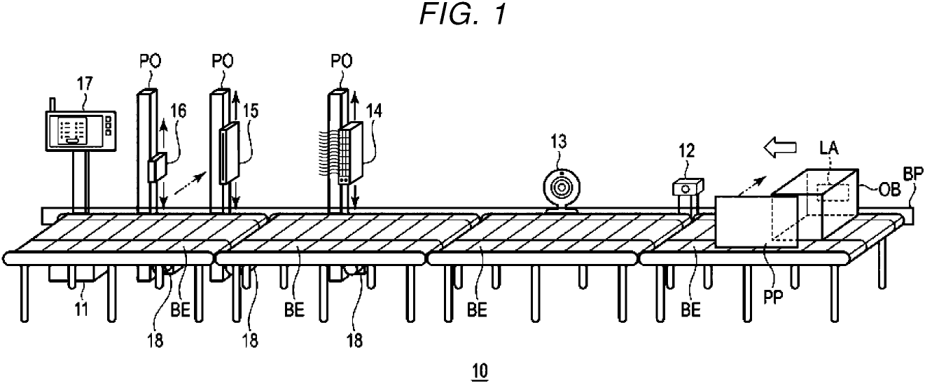

FIG. 1 is a diagram showing a configuration example of a printing system 10 according to a first embodiment. The printing system 10 according to the embodiment is a system configured to rewrite printing information in order to reuse an object to be printed OB on which printing information is already printed using thermochromic ink.

The printing system 10 includes a conveyance belt BE on which the object to be printed OB is placed. The printing information of the object to be printed OB is rewritten by moving the conveyance belt BE using a drive source which is not shown at a constant speed and conveying the object to be printed OB placed thereon to a plurality of process positions at which the printing information is rewritten, as shown by a hollow arrow in FIG. 1. The plurality of processes include an erasing process of applying heat to the printing information to erase the same, a printing process of printing necessary information again using thermochromic ink, and a reading process of reading the printed printing information. As described above, the conveyance belt BE and the drive source which is not shown form a conveyance machine configured to convey the object to be printed OB. Although FIG. 1 shows four conveyance belts BE, the conveyance belt BE may be formed with one conveyance belt configured to cover all the process positions, or a plurality of conveyance belts other than four may be provided to cover all the process positions.

The object to be printed OB has a rectangular parallelepiped shape such as a corrugated cardboard and a returnable box, and a label LA having a color different from that of the object to be printed OB, such as white, is attached to one printing surface to be printed. The printing information is printed on the label LA. In other words, the label LA is a printing region, and a surface to which the label LA is attached is a printing surface. The printing information includes a character string representing write information such as a destination of the object to be printed OB, that is, a destination of an article stored in the object to be printed OB. Further, at least a code image such as a QR code (registered trademark) configured to encode the character string of the write information is printed in the printing region. For example, the object to be printed OB, having the article stored therein, is picked up by a worker or an appropriate pick-up mechanism, and the printing surface is placed on the conveyance belt BE toward a side of the conveyance belt BE, that is, toward a direction perpendicular to a conveyance direction of the object to be printed OB. Here, the label LA may have the printing information about a previously stored article printed thereon, that is, the label LA does not have the printing information about a currently stored article printed thereon. Accordingly, the label LA is required to be rewritten.

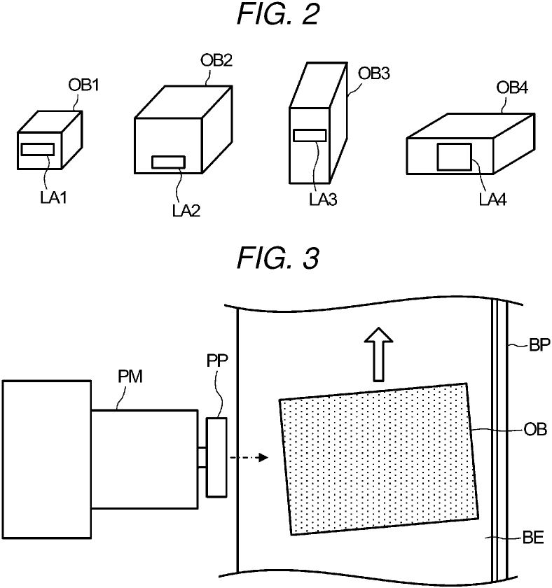

FIG. 2 is a diagram showing examples of various objects to be printed which are to be used. Here, four objects to be printed OB1, OB2, OB3, and OB4 are shown. As shown in the drawing, the objects to be printed OB may have a different ratio in size, height, width, and depth. Each of the labels LA including LA1, LA2, LA3, and LA4 is attached to a corresponding side surface of respective objects to be printed OB, such that printing information can be printed on each label LA serving as a printing region. The size and aspect ratio of each label LA may not be constant.

The printing system 10 may print the printing information directly on one side surface of the object to be printed OB instead of printing the same on the label LA. In this case, a whole side surface of the object to be printed OB is not used as a printing region. Here, a region having a margin to some extent from the edge region of the whole side surface is preferably used as a printing region. This is because the object to be printed OB having a rectangular parallelepiped shape generally has a high possibility of being damaged in the edge region thereof. Accordingly, due to this damage, the printing information printed thereon becomes illegible, and if the object to be printed OB is reused, the printing information that is already printed thereon may not be appropriately erased, and new printing information may not be appropriately printed thereon.

The printing system 10 may use both an object to be printed OB having the label LA attached thereto and an object to be printed OB without the label LA. Hereinafter, the printing system 10 according to the embodiment will be described as a system capable of using both the objects to be printed OB.

The printing system 10 further includes a control unit 11, a timing sensor 12, an object sensor 13, a heater 14, a printer 15, a code reader 16, a user interface 17, and three motors 18. The timing sensor 12, the object sensor 13, the heater 14 disposed at an erasing process position, the printer 15 disposed at a printing process position, the code reader 16 disposed at a reading process position, and the user interface 17 are disposed in this order along the conveyance belt BE. In other words, the erasing process position, the printing process position, and the reading process position are disposed in this order.

The control unit 11 is a computer configured to control the operation of each component of the printing system 10.

The timing sensor 12 is formed of, for example, a photoelectric sensor, and detects that the object to be printed OB arrives at the position of the timing sensor 12. The control unit 11 can control operation timings of the object sensor 13, the heater 14, the printer 15, and the code reader 16 based on a movement speed of the object to be printed OB by the conveyance belt BE, based on the time when the timing sensor 12 detects the arrival of the object to be printed OB.

The object sensor 13 is formed of an image sensor such as a camera, and captures an image of the object to be printed OB. The control unit 11 can detect, by a well-known image process, presence or absence of the label LA on the object to be printed OB and the size of the object to be printed OB from the captured image of the object to be printed OB. That is, the control unit 11 detects, with respect to the label LA, a distance from a front end portion in the conveyance direction on the printing surface of the object to be printed OB, a distance from an upper end portion on the printing surface (a distance from a surface facing a placement surface), and vertical and horizontal sizes. If the label LA is not attached, the control unit 11 detects the vertical and the horizontal sizes of the object to be printed OB. Then, as will be described later in detail, the control unit 11 can determine the size and the position of a printing region in which printing information is printed based on the detected size of the label LA or the object to be printed OB and known information thereon. In this manner, the object sensor 13 and the control unit 11 form a printing region detection unit configured to detect the size and the position of a printing region in which printing information is printed using thermochromic ink on the object to be printed being conveyed.

The heater 14 is a heat source configured to erase thermochromic ink, the heat source irradiating a printing region with heat capable of erasing printing information being printed using thermochromic ink in a printing region. The heater 14 is supported by a support column PO in a state of being movable in a height direction by a motor 18 as shown by a solid arrow in FIG. 1. In the embodiment, a mechanism configured to convert rotational force of the motor 18 into movement force in a linear direction of the heater 14 is not particularly limited. A support mechanism for the support column PO may be adapted to a conversion mechanism of this driving force. Any support mechanism may be used as long as the heater 14 can be supported so that a support direction thereof becomes a direction in which the heat is applied to the printing region from the direction perpendicular to the conveyance direction of the object to be printed OB, that is, from a side surface side in the conveyance direction. The control unit 11 can control the motor 18 based on the size and the position of the printing region determined using the object sensor 13, thereby making it possible to adjust a height position of the heater 14 so as to match the printing region. The control unit 11 operates the heater 14 at a timing at which the printing region passes through the heater 14, the timing being calculated based on a detection time point by the timing sensor 12, thereby making it possible to erase the printing information being printed using thermochromic ink. In this manner, the heater 14 and control unit 11 form an erasing unit configured to allow the heater 14 whose height position is adjusted depending on a printing region to apply heat from a direction perpendicular to the conveyance direction of the object to be printed OB according to a timing at which the printing region passes through the heater 14, the timing being determined based on the size and the position of the printing region, thereby erasing printing information in the printing region, the printing information being printed using thermochromic ink.

The printer 15 is formed of, for example, an inkjet printer using thermochromic ink. The printer 15 is supported by the support column PO in a state of being movable in the height direction by the motor 18 as shown by the solid arrow in FIG. 1. The conversion mechanism of the driving force of the motor 18 and the support mechanism of the printer 15 are not specified in the embodiment in the same manner as described in the case of the heater 14. The printer 15 is supported by the support column PO so as to print printing information in a printing region from the direction perpendicular to the conveyance direction of the object to be printed OB, that is, from the side surface side in the conveyance direction. The control unit 11 controls the motor 18 based on the size and the position of the printing region determined using the object sensor 13, thereby making it possible to adjust the height position of the printer 15 so as to match the printing region. The control unit 11 can print the printing information using thermochromic ink by operating the printer 15 at a timing at which the printing region passes through the printer 15, the timing being calculated based on a detection time point by the timing sensor 12. As described above, the printer 15 and the control unit 11 form a printing unit including the printer 15 using thermochromic ink disposed in a rear stage of the heater 14 in the conveyance direction, the printing unit being configured to print information on the object to be printed OB from the direction perpendicular to the conveyance direction by the printer 15 whose height position is adjusted depending on a printing region according to a timing at which the printing region passes through the printer 15, the timing being determined based on the printing region.

The sizes of the heater 14 and the printer 15 in the height direction are sizes that cover the height direction of the printing region. In other words, the size of the printing region in the height direction is specified by the sizes of the heater 14 and the printer 15 in the height direction. This is because an object to be printed OB is conveyed at a constant speed by the conveyance belt BE. Here, if erasing and/or printing is performed by temporarily stopping the object to be printed OB at the erasing process position and/or the printing process position for a short period of time, this specification may not be required.

The code reader 16 is supported by the support column PO in a state of being movable in the height direction by the motor 18 as shown by the solid arrow in FIG. 1. The conversion mechanism of the driving force of the motor 18 and the support mechanism of the code reader 16 are also not specified in the embodiment. The code reader 16 is supported by the support column PO so as to read the code image in the printing information printed on the label LA from the direction perpendicular to the conveyance direction of the object to be printed OB, that is, from the side surface side in the conveyance direction. The control unit 11 controls the motor 18 based on the size and the position of the printing region determined using the object sensor 13, thereby making it possible to adjust the height position of the code reader 16 so as to match the printing position of the code image. The control unit 11 operates the code reader 16 at a timing at which the printing region passes through the code reader 16, the timing being calculated based on a detection time point by the timing sensor 12, thereby making it possible to read the code image printed thereon and decode write information or the like.

The user interface 17 is a system monitor configured to display various kinds of information from the control unit 11. The user interface 17 can include a key and a button through which various instructions are input to the control unit 11. The user interface 17 may include a touch panel in which touch keys are disposed on a monitor screen such as a liquid crystal display.

If accurate operation is required in the erasing process, the printing process, and the reading process, a printing region is required to face the heater 14, the printer 15, and the code reader 16. Particularly, if the printer 15 does not face a printing surface, characters and images are distorted, and as such, it is difficult to distinguish the characters, or the code reader 16 cannot read the code image. Meanwhile, it is difficult to place objects to be printed OB on the conveyance belt BE in the aligned direction, the objects to be printed OB being required to be placed thereon one after another.

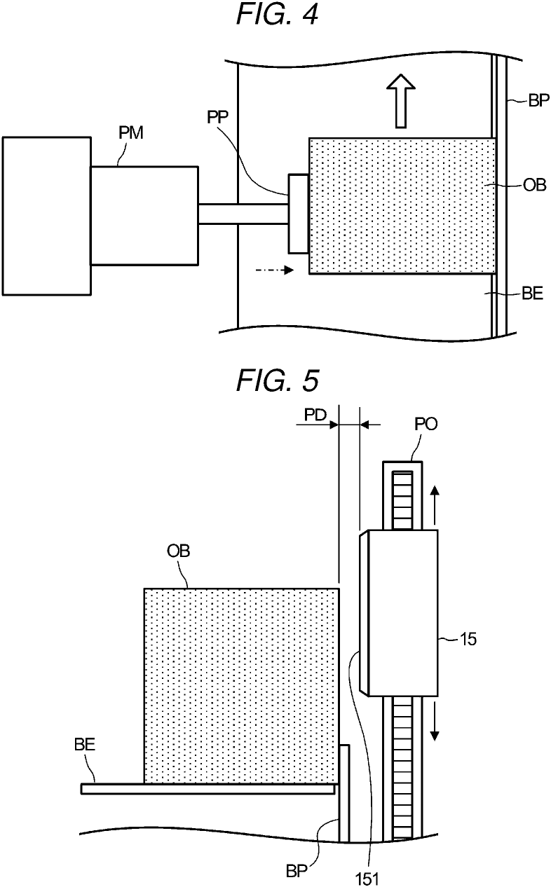

Therefore, the printing system 10 according to the embodiment includes a butt plate BP and a pressing plate PP with the conveyance belt BE sandwiched between opposite sides in the conveyance direction. The butt plate BP extends along the conveyance belt BE. FIG. 3 is a schematic diagram showing a pre-operation state of the pressing plate PP, and FIG. 4 is a schematic diagram showing a post-operation state of the pressing plate PP. The pressing plate PP is attached to a pressing mechanism PM, and moves toward the butt plate BP by the pressing mechanism PM as shown by arrows having an alternate long and short dash line in FIGS. 1, 3, and 4. During the movement operation thereof, the pressing plate PP abuts on an object to be printed OB being conveyed by the conveyance belt BE, presses the object to be printed OB toward the butt plate BP, and causes the printing surface of the object to be printed OB to abut against the butt plate BP. As a result, the printing surface of the object to be printed OB is aligned in parallel with the conveyance direction, and the object to be printed OB is conveyed in this state. A contact surface of the butt plate BP that contacts the object to be printed OB is formed of a low friction material so as not to affect the conveyance of the object to be printed OB. Pressing force of the pressing plate PP by the pressing mechanism PM is also set to a value that does not affect a conveyance speed of the object to be printed OB. By adjusting the pressing force by feedbacking repulsive force by the object to be printed OB, it may be possible to cope with a weight change in the object to be printed OB, the weight change being caused by a stored article. If the printing surface of the object to be printed OB abuts on the butt plate BP, the pressing plate PP is retracted to an initial position thereof. For example, whether or not the printing surface of the object to be printed OB abuts on the butt plate BP can be detected from a change in repulsive force, or can be determined from an image captured by a camera.

An operation timing of the pressing plate PP is, for example, a timing in response to an operation instruction by a worker if the worker places an object to be printed OB on the conveyance belt BE. If the object to be printed OB is placed thereon by a pickup mechanism, it is also possible for the control unit 11 to perform timing control based on a placement operation of the pickup mechanism.

In the example of FIG. 1, the butt plate BP is configured as a single plate, and may be configured with a plurality of consecutive plates. The butt plate BP may be disposed at least from a position at which the pressing plate PP is disposed to the printing process position.

FIG. 5 is a schematic diagram showing a positional relationship between the object to be printed OB and the printer 15. If the object to be printed OB is conveyed to the printing process position, a printing surface including a printing region is parallel with the conveyance direction. The printer 15 is supported by the support column PO so that a printer head 151 configured to eject ink droplets of thermochromic ink is oriented in the direction perpendicular to the conveyance direction, in other words, a printing angle is perpendicular to the printing surface. Next, an installation position of the butt plate BP disposed along the conveyance belt BE is determined so that a distance between the printing surface of the object to be printed OB and the printer head 151 becomes a specified distance PD suitable for printing the printing information. In the case of other process positions as well, the butt plate BP can be installed so that a distance between each of the heater 14 and the code reader 16 and the printing surface of the object to be printed OB becomes a constant distance corresponding to the specified distance PD.

In this manner, the printing system 10 includes a facing mechanism configured to cause the printing surface including the printing region of the object to be printed OB to face the printer head 151 of the printer 15 at least at the time when the printing unit prints information. The facing mechanism includes the butt plate BP extending along the conveyance belt BE up to at least the installation position of the printer 15, wherein the butt plate BP is formed to rise from a surface on the conveyance belt BE side at the specified distance PD from the printer head 151, and the pressing mechanism PM configured to press the object to be printed OB against the butt plate BP, wherein the pressing mechanism PM is disposed in a front stage of the installation position of the printer 15 in the conveyance direction.

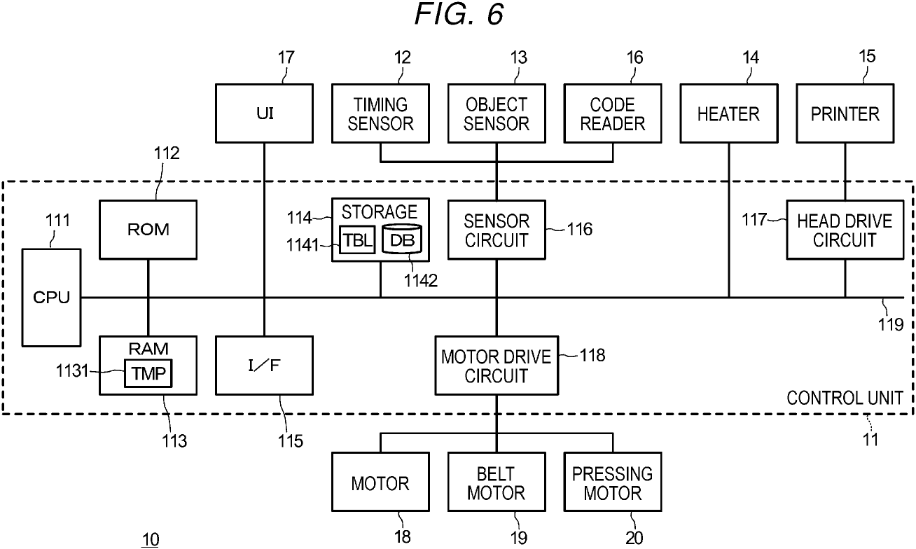

FIG. 6 is a block diagram showing an electrical configuration of the printing system 10. The control unit 11 includes a CPU 111, a ROM 112, a RAM 113, a storage 114, an interface 115, a sensor circuit 116, a head drive circuit 117, and a motor drive circuit 118 which are connected to the CPU 111 via a bus 119. In FIG. 6, the “interface” is abbreviated as “I/F”.

The CPU 111 is a processor having a function of controlling the overall operation of the printing system 10. The CPU 111 implements various functions by executing programs stored in advance in the ROM 112. The CPU 111 can execute a plurality of information processes at the same time using multi-core and multi-threaded processors. Some of the various functions implemented by allowing the CPU 111 to execute the programs may be implemented by hardware circuits such as an application specific integrated circuit (ASIC), a field-programmable gate array (FPGA), and a graphics processing unit (GPU). In this case, the CPU 111 controls the functions executed by the hardware circuits.

The ROM 112 is a non-volatile memory in which a control program, control data, and the like are stored in advance.

The RAM 113 is a volatile memory. The RAM 113 temporarily stores data or the like being processed by the CPU 111. The RAM 113 may store data required to execute a program, an execution result of the program, and the like. For example, the RAM 113 can include a temporary storage unit 1131 configured to store write information to be written as printing information and the code image. In FIG. 6, the “temporary storage unit” is referred to as “TMP”.

The storage 114 is an auxiliary storage device such as an electric erasable programmable read-only memory (EEPROM) (registered trademark), a hard disc drive (HDD), and a solid state drive (SSD). The storage 114 non-volatilely stores data to be used for the CPU 111 to perform various processes and data generated by the processes of the CPU 111. The storage 114 includes, for example, a printing region table 1141 configured to describe printing regions of the objects to be printed OB having various sizes, and a database 1142 configured to store write information read by the code reader 16. In FIG. 6, the “printing region table” is abbreviated as “TBL”, and the “database” is abbreviated as “DB”.

The interface 115 is an interface configured to transmit and receive data to and from an external device via a network such as a LAN. The interface 115 may be an interface configured to write and read data to and from removable memory mediums such as a USB memory and a memory card.

The sensor circuit 116 is connected to the timing sensor 12, the object sensor 13, and the code reader 16. The sensor circuit 116 receives a signal or data therefrom and transmits the same to the CPU 111.

The head drive circuit 117 drives the printer head 151 of the printer 15 based on printing data in accordance with the write information stored in the temporary storage unit 1131 of the RAM 113, the printing data being input from the CPU 111.

The motor drive circuit 118 controls the drive of the motor 18, a belt motor 19, and a pressing motor 20 according to a signal from the CPU 111. The motor drive circuit 118 can independently control the motor 18 for the heater 14, the motor 18 for the printer 15, and the motor 18 for the code reader 16. The belt motor 19 is a motor configured to drive the conveyance belt BE. Only one belt motor 19 is shown as a representative, and a plurality of belt motors 19 may be provided. The pressing motor 20 is a motor for the pressing mechanism PM configured to move and operate the pressing plate PP. However, in the configuration in which the operation of the pressing mechanism PM is performed in response to an operation instruction from a worker, the pressing motor 20 is not required to be connected to the motor drive circuit 118.

The user interface 17 and the heater 14 can also be connected to the bus 119 directly or via an interface which is not shown and controlled by the CPU 111. In FIG. 6, the “user interface” is abbreviated as “UI”.

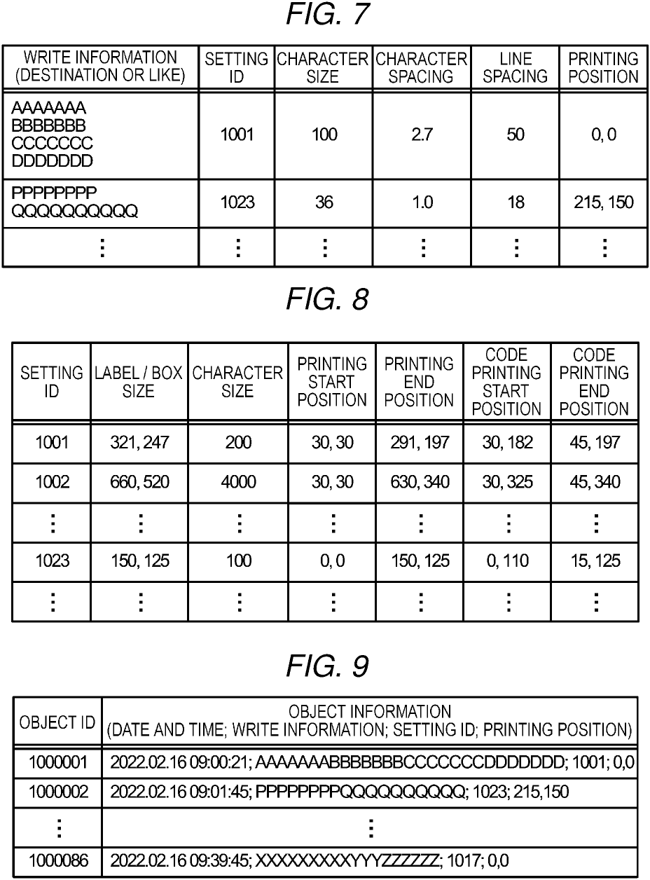

FIG. 7 is a diagram showing an example of information related to the write information stored in the temporary storage unit 1131 of the RAM 113. As shown in FIG. 7, the temporary storage unit 1131 can be configured to store a plurality of records, wherein each record includes write information to be printed as printing information in a printing region of an object to be printed OB, a setting ID configured to specify the printing region, information related to a printing format, and a printing position. Here, the order of listing items of the information related to the write information stored in the temporary storage unit 1131 is not limited to this order, and the items thereof may be replaced with other items or other items may be added thereto.

Here, the write information includes, for example, a destination of the object to be printed OB. For example, the write information can be generated by the CPU 111 in response to reception of character input by the operation of a worker of the user interface 17, and the same can be stored in the temporary storage unit 1131. Alternatively, the CPU 111 can control the interface 115 to receive write information transmitted from an external device via a network or to read write information stored in a memory medium, and the received or read write information can be stored in the temporary storage unit 1131.

The setting ID corresponds to an identification symbol uniquely allocated to each of the printing regions in the objects to be printed OB having various sizes described in the printing region table 1141 of the storage 114, which will be described below with reference to FIG. 8. The CPU 111 refers to the printing region table 1141 to acquire the setting ID indicating a printing region corresponding to the size and the position determined using the object sensor 13, and stores the setting ID in the temporary storage unit 1131.

The information related to the printing format includes each piece of information on a character size, character spacing, and line spacing. The CPU 111 determines these values based on the write information and the determined size of the printing region, and stores the same in the temporary storage unit 1131. Here, although the unit is used as a character point, the same is not limited thereto.

The printing position is an origin position that defines the position of the printing region. If the printing region is the label LA attached to the object to be printed OB, the position at which the label LA is attached to the object to be printed OB may vary. If the printing region determined using the object sensor 13 is the label LA, the CPU 111 stores the attachment position of the label LA as the printing position. Further, if the printing region is one side surface of the object to be printed OB, the CPU 111 stores the origin 0, 0 as the printing position. Here, the unit of the printing position is mm, the order of arrangement of values is the order of width and height, and the origin 0, 0 is set as an upper end of the object to be printed OB in the conveyance direction.

Every time the CPU 111 acquires new write information, the CPU 111 additionally stores the same as a final record of the temporary storage unit 1131, determines the setting ID and the information related to the printing format with respect to the additionally stored write information, and stores the same in the final record. Here, the CPU 111 may change a line feed of the write information when determining the information related to the printing format. If the first stored write information is printed by the printer 15, the record is deleted from the temporary storage unit 1131.

FIG. 8 is a diagram showing an example of information stored in the printing region table 1141 of the storage 114. The printing region table 1141 is a table in which information on a printing region is registered in advance in association with a unique setting ID. The printing region table 1141 includes, as the information on the printing region, a label/box size, a character size, a printing start position, a printing end position, a code printing start position, and a code printing end position. Here, the unit of size and position is mm. Values of the size and position are arranged in the order of width and height, and the origin 0, 0 is set as the upper end of the label LA or the object to be printed OB in the conveyance direction. Of course, these units, arrangement order, and origin are not limited thereto. The order of listing items of the information on the printing region in the printing region table 1141 is also not limited to this order, and the items thereof may be replaced with other items or other items may be added thereto.

The label/box size is the size of the label LA attached to the object to be printed OB or the size of the object to be printed OB to which the label LA is not attached. The character size is a maximum value of the character size if the printing information is printed in the printing region.

The printing start position and the printing end position are diagonally positioned in a region used to print a character string or the like in accordance with write information in a printing region, and the code printing start position and the code printing end position are diagonally positioned in a region used to print the code image in a printing region. In other words, the printing start position and the printing end position indicate the size and the position of a region in which the write information can be printed, and the code printing start position and code printing end position indicate the size and the position of a region in which the code image can be printed.

As described above, in consideration of the possibility of damage to an edge region of the object to be printed OB, the whole side surface of the object to be printed OB indicated by the label/box size cannot be used as a printing region. In addition, since a lower portion of the object to be printed OB is blocked by the butt plate BP, printing cannot be performed on the lower portion thereof. The size of the printable region is also limited depending on the size of the printer head 151 of the printer 15. Therefore, the printing region table 1141 registers the size of a region that can be actually used to print the write information and the code image.

For example, the information on the printing region is acquired in advance by allowing the CPU 111 to receive an input by the operation of a worker of the user interface 17, or acquired from an external device or a memory medium using the interface 115. Then, the setting ID is freely and selectively allocated thereto and registered in the printing region table 1141. The setting ID is a serial number here. Here, if an object to be printed OB having a size not registered in the printing region table 1141 is conveyed, the information on the printing region may be updated each time.

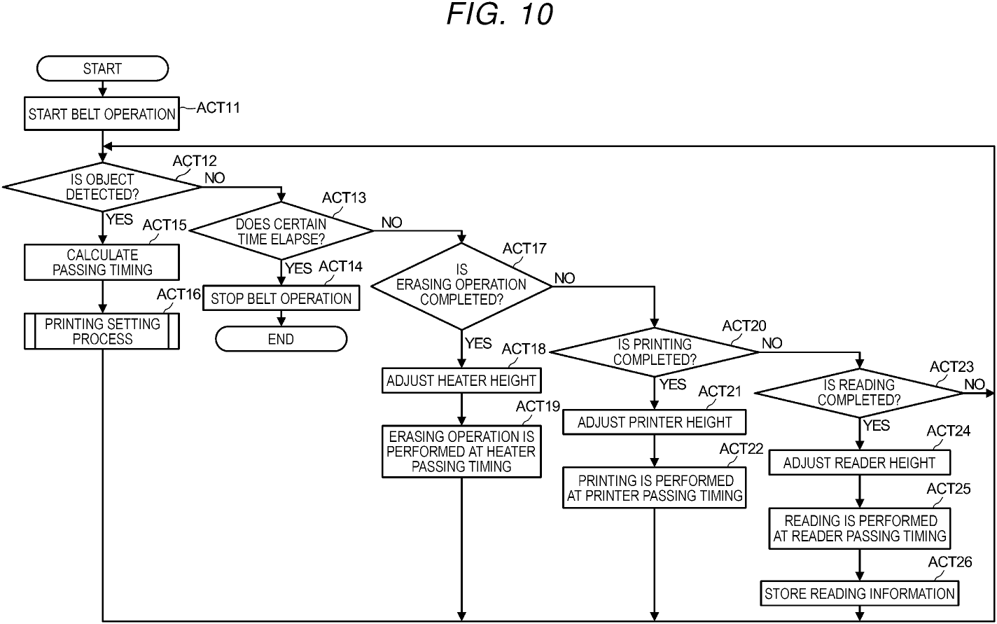

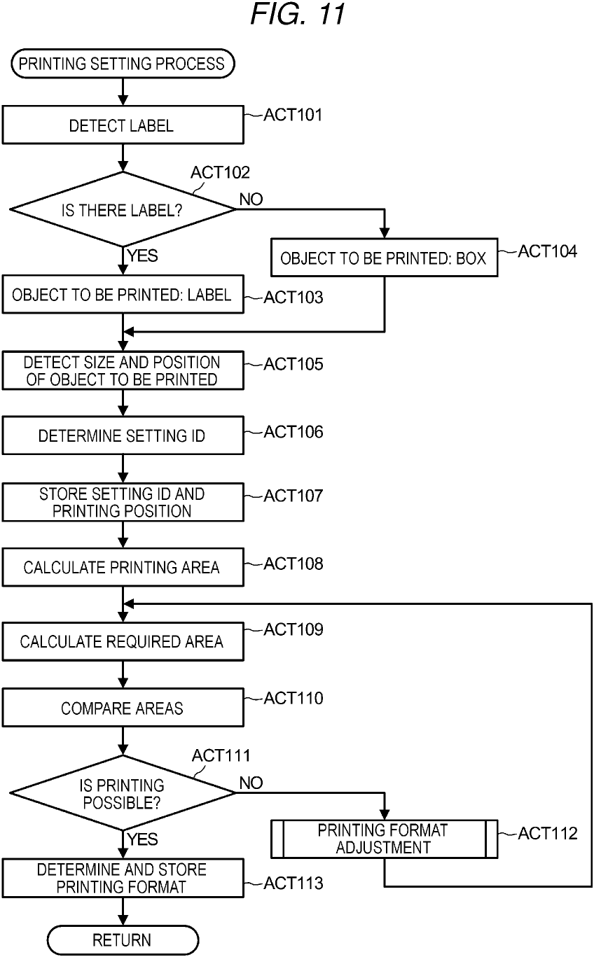

FIG. 9 is a diagram showing an example of object information stored in the database 1142 of the storage 114. The database 1142 stores contents of the printing information read by the code reader 16 as object information in association with a unique object ID. The object ID is freely and selectively allocated thereto by the CPU 111 and is a serial number here. The printing information includes the date and time of printing in addition to the write information, so the object information also includes the date and time of printing. The code image may include any information other than the printing information. For example, the code image can include a setting ID and a printing position as any information. In this case, the object information may also include the setting ID and the printing position, as shown in FIG. 9.

FIG. 10 is a flowchart showing an example of control operation of the control unit 11. If the control unit 11 is started by turning on power, the CPU 111 displays an operation menu on the user interface 17 according to a program stored in the ROM 112, and executes the operation shown in this flowchart in response to printing start operation in the user interface 17. In conjunction with the operation shown in this flowchart, the CPU 111 can execute the operation of storing write information in the temporary storage unit 1131 of the RAM 113, the write information being input, received, or read by the user interface 17 or the interface 115.

First, the CPU 111 controls the belt motor 19 by the motor drive circuit 118 to start the operation of the conveyance belt BE (ACT 11).

After that, the CPU 111 determines whether or not the timing sensor 12 detects the arrival of an object to be printed OB based on a signal from the sensor circuit 116 (ACT 12). When determining that the arrival of the object to be printed OB is not detected (ACT 12, NO), the CPU 111 determines whether or not a certain time elapses after detecting the arrival of the previous object to be printed OB (ACT 13). When determining that a certain time elapses (ACT 13, YES), the CPU 111 controls the belt motor 19 by the motor drive circuit 118 to stop the operation of the conveyance belt BE (ACT 14). Next, the CPU 111 ends the operation shown in this flowchart.

If the object to be printed OB is placed on the conveyance belt BE before the above-mentioned certain time elapses, the pressing plate PP is moved in response to an instruction from a worker and the object to be printed OB abuts against the butt plate BP. Alternatively, in response to reception of a placement signal from a pickup mechanism by the interface 115, the CPU 111 operates the pressing motor 20 by the motor drive circuit 118 to cause the object to be printed OB to abut against the butt plate BP.

If the object to be printed OB arrives at the timing sensor 12 while the printing surface thereof is in contact with the butt plate BP in this manner, the object to be printed OB is detected by the timing sensor 12. When determining that the timing sensor 12 detects the arrival of the object to be printed OB (ACT 12, YES), the CPU 111 calculates a passing timing at which the object to be printed OB passes through each process position of erasing, printing, and reading (ACT 15). For example, the process is performed as follows. First, the CPU 111 calculates a conveyance speed of the object to be printed OB by the conveyance belt BE based on a rotation speed of the belt motor 19, and stores the calculated conveyance speed thereof in the RAM 113. The CPU 111 stores the time when the timing sensor 12 detects the arrival of the object to be printed OB in the RAM 113 in order to set the stored time as a reference time. Next, the CPU 111 reads out distances from the timing sensor 12 to each of the heater 14, the printer 15, and the code reader 16 in each process, the distances being stored non-volatilely in the ROM 112 or the storage 114, and calculates time from the timing at which the object to be printed OB arrives at the timing sensor 12 to each of the process positions by dividing each distance by the conveyance speed thereof. The CPU 111 stores, in the RAM 113, the calculated passing timing at which the object to be printed OB passes through each of the process positions.

Thereafter, the CPU 111 executes a printing setting process to set information related to the write information stored in the temporary storage unit 1131 of the RAM 113 (ACT 16). Then, if the printing setting process is completed, the CPU 111 proceeds to the process of ACT 12.

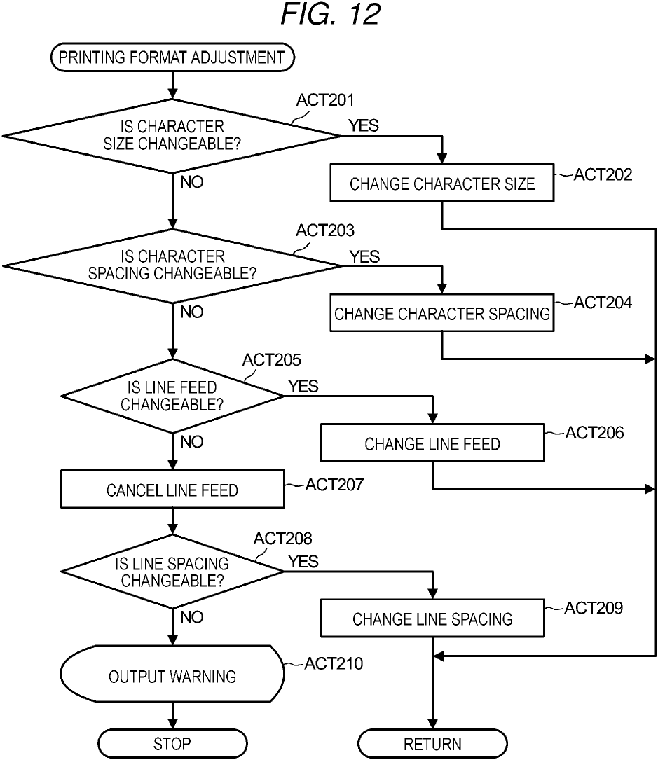

FIG. 11 is a flowchart showing the details of the printing setting process. The CPU 111 detects a label LA attached to the object to be printed OB from an image signal of the object sensor 13, the image signal being input via the sensor circuit 116 (ACT 101). For example, the detection of the label LA can be easily performed by making the label LA a specific color or attaching a predetermined non-rewritable mark or pattern to the label LA. Then, the CPU 111 confirms presence or absence of the label LA (ACT 102). When determining that there is the label LA (ACT 102, YES), the CPU 111 determines that an object to be printed is a label (ACT 103). When determining that there is no label LA (ACT 102, NO), the CPU 111 determines that an object to be printed is a box (ACT 104).

Thereafter, the CPU 111 detects the vertical and horizontal sizes of the determined object to be printed and the position thereof from the image signal used to detect the label LA by a well-known image process (ACT 105). That is, if the object to be printed is the label LA, the CPU 111 detects, as a position of the label LA, a distance of the label LA from a front end portion of the printing surface of the object to be printed OB in the conveyance direction and a distance thereof from an upper end portion of the printing surface thereof (a distance thereof from a surface facing a placement surface), and detects the size of the label LA itself as the vertical and horizontal sizes thereof. Further, if the object to be printed is the box, the CPU 111 detects the position thereof as origin 0, 0 indicating the upper end portion of the object to be printed OB in the conveyance direction, and detects the size of the object to be printed OB itself as the vertical and horizontal sizes thereof.

The CPU 111 determines a corresponding setting ID by retrieving the printing region table 1141 of the storage 114 using the detected size of the object to be printed as a retrieval key (ACT 106). Then, the CPU 111 stores the determined setting ID and the detected position in association with corresponding write information in the temporary storage unit 1131 of the RAM 113 (ACT 107). For example, the CPU 111 stores the determined setting ID and the detected position as a setting ID and a printing position in a record in which the setting ID is not yet stored among the records of the write information in the temporary storage unit 1131.

Thereafter, the CPU 111 reads out, from the printing region table 1141 of the storage 114, a printing start position, a printing end position, a code printing start position, and a code printing end position corresponding to the setting ID, and calculates a printing area usable to be printed the write information in the printing region (ACT 108). Here, the printing area does not mean a simple total area such as a few square millimeters, but also considers the shape thereof. For example, in the setting ID of “1001”, the total area of the printing region is (291 - 30) * (197 - 30) = 43,587 from the printing start position and the printing end position. However, since the code image is also printed, the total area thereof cannot be used only for the write information. In the embodiment, the code image is printed on the lower right of the printing region. Accordingly, the printing area becomes (291 - 30) * (182 -30) = 39,672 and (291 - 45) * (197 - 182) = 3,690.

The CPU 111 calculates a required area, which is a printing area required to be printed the corresponding write information being stored in the temporary storage unit 1131 of the RAM 113 (ACT 109). For example, if the CPU 111 reads out a character size corresponding to the setting ID from the printing region table 1141, and prints the write information using the character size and predetermined character spacing and line spacing for each character size, the CPU 11 calculates what kind of printing area it becomes.

Then, the CPU 111 compares the calculated printing area of the printing region with the required area (ACT 110), and determines whether printing can be performed (ACT 111). If the required area is equal to or less than the printing area (the required area ≤ the printing area), the CPU 111 determines that printing can be performed.

When determining that the required area is larger than the printing area (the required area > the printing area) (ACT 111, NO), the CPU 111 adjusts a printing format.

FIG. 12 is a flowchart showing the details of printing format adjustment. First, the CPU 111 determines whether or not the character size can be changed (ACT 201). This can be determined by whether or not the character size reaches a lower limit thereof. When determining that the character size can still be changed (ACT 201, YES), the CPU 111 causes the character size to be smaller by one size (ACT 202). Then, the CPU 111 proceeds to the process of ACT 109 in FIG. 11, calculates the required area of the adjusted printing format, that is, the format having the reduced character size, and determines again whether or not printing can be performed.

If the character size is changed in this manner and printing cannot be performed even with the lower limit of the character size, it is determined that the character size cannot be changed in ACT 201. In this case (ACT 201, NO), the CPU 111 determines whether or not the character spacing can be changed (ACT 203). This can be determined by whether or not the character spacing reaches a lower limit thereof. When determining that the character spacing can still be changed (ACT 203, YES), the CPU 111 causes the character spacing to be narrower by one step (ACT 204). Then, the CPU 111 proceeds to the process of ACT 109 in FIG. 11, calculates the required area of the adjusted printing format, that is, the format having the narrowed character spacing, and determines again whether or not printing can be performed.

If the character spacing is changed in this manner and printing cannot be performed even with the lower limit of the character spacing, it is determined that the character spacing cannot be changed in ACT 203. In this case (ACT 203, NO), the CPU 111 determines whether or not the line feed can be changed (ACT 205). This can be determined by whether or not the current number of lines is one. Even if the number of lines is not one, if the line feed is canceled in ACT 207 to be described below, it is determined that the line feed cannot be changed. When determining that the line feed can still be changed (ACT 205, YES), the CPU 111 eliminates one line feed and reduces the number of lines by one (ACT 206). Then, the CPU 111 proceeds to the process of ACT 109 in FIG. 11, calculates the required area of the adjusted printing format, that is, the format having the reduced number of lines, and determines again whether or not printing can be performed.

If the number of lines is changed in this manner and printing cannot be performed even when the number of lines is reduced to one line, it is determined that the line feed cannot be changed in ACT 205. In this case (ACT 205, NO), the CPU 111 cancels the line feed and restores the previous line feed state (ACT 207). Here, the process in ACT 207 is performed only once, and is skipped from the second time. Then, the CPU 111 determines whether or not a line-spacing size can be changed (ACT 208). This can be determined by whether or not the line-spacing size reaches a lower limit thereof. When determining that the line-spacing size can still be changed (ACT 208, YES), the CPU 111 causes the line-spacing size to be narrower by one size (ACT 209). Then, the CPU 111 proceeds to the process of ACT 109 in FIG. 11, calculates the required area of the adjusted printing format, that is, the format having the narrowed line-spacing size, and determines again whether or not printing can be performed.

If the line-spacing size is changed in this manner and printing cannot be performed even with the lower limit of the line-spacing size, it is determined that the line-spacing size cannot be changed in ACT 208. In this case (ACT 208, NO), the CPU 111 displays a warning output on the user interface 17 (ACT 210). Then, the CPU 111 stops the operation of the printing system 10 and causes a worker to perform necessary correction operation.

Referring back to FIG. 11, if the required area is equal to or less than the printing area (the required area ≤ the printing area) and it is determined that printing can be performed (ACT 111, YES), the CPU 111 determines the printing format used in calculating the required area in ACT 109 as the printing format to be used for actual printing, and stores the same (ACT 113). That is, the CPU 111 causes the temporary storage unit 1131 of the RAM 113 to store information related to the printing format, that is, the character size, the character spacing, and the line spacing in association with the corresponding write information. If the line feed in the write information is changed, the CPU 111 rewrites the corresponding write information according to the change of the line feed. After that, the CPU 111 proceeds to the process of ACT 12 in FIG. 10.

Referring back to FIG. 10, when determining that the arrival of the object to be printed OB is not detected (ACT 12, NO) but a certain time does not elapse after the arrival of the previous object to be printed OB is detected (ACT 13, NO), the CPU 111 determines whether or not previous erasing operation is completed (ACT 17). The previous erasing operation indicates erasing operation for the object to be printed OB having a timing of arriving at the heater 14 among the objects to be printed OB that are conveyed one after another. That is, it is required to set the heater 14 at a height position corresponding to a printing region in each object to be printed OB, but the heater 14 is not to be set at a height position corresponding to the next object to be printed OB before the erasing operation for the object to be printed OB arriving thereat is completed. Therefore, in ACT 17, it is required to confirm the end of the erasing operation.

When determining that the previous erasing operation is completed (ACT 17, YES), the CPU 111 adjusts the height of the heater 14 to a printing start position of an object to be printed OB that will arrive at the heater 14 next (ACT 18). For example, the CPU 111 reads out, from the temporary storage unit 1131 of the RAM 113, a setting ID and a printing position for write information to be printed on the object to be printed OB, and reads out the printing start position from the printing region table 1141 of the storage 114 based on the setting ID. Then, according to the read printing position or printing start position, the CPU 111 drives the motor 18 for the heater 14 by the motor drive circuit 118, thereby adjusting the height of the heater 14. If the printing position is 0, 0, the height of the printing region becomes the printing start position. If the printing position is any other value, the printing region is the label LA, and as such, the height of the printing region becomes the printing position.

Next, the CPU 111 reads out the passing timing of the object to be printed OB stored in the RAM 113, operates the heater 14 in accordance with the timing at which the printing start position thereof passes through the heater 14, and applies heat to the printing region to erase the printing information printed thereon using thermochromic ink (ACT 19). After that, the CPU 111 proceeds to the process of ACT 12.

If the CPU 111 is a multi-core or multi-threaded CPU, it is possible to execute another process in parallel with the operation shown in this flowchart. Accordingly, when determining that the previous erasing operation is completed (ACT 17, YES), the CPU 111 may start the processes of ACT 18 and ACT 19 in parallel with the operation of this flowchart, and may immediately proceed to the process of ACT 12.

When determining that the previous erasing operation is not completed (ACT 17, NO), the CPU 111 determines whether or not previous printing operation is completed (ACT 20). The previous printing operation indicates printing operation for the object to be printed OB having a timing of arriving at the printer 15 among the objects to be printed OB that are conveyed one after another. That is, it is required to set the printer 15 at a height position corresponding to a printing region in each object to be printed OB, but the printer 15 is not to be set at a height position corresponding to the next object to be printed OB before the printing operation for the object to be printed OB arriving thereat is completed. Therefore, in ACT 20, it is required to confirm the end of the printing operation.

When determining that the previous printing operation is completed (ACT 20, YES), the CPU 111 adjusts the height of the printer 15 to a printing start position of an object to be printed OB that will arrive at the printer 15 next (ACT 21). For example, the CPU 111 reads out, from the temporary storage unit 1131 of the RAM 113, a setting ID and a printing position for write information to be printed on the object to be printed OB, and reads out the printing start position from the printing region table 1141 of the storage 114 based on the setting ID. Then, according to the read printing position or printing start position, the CPU 111 drives the motor 18 for the printer 15 by the motor drive circuit 118, thereby adjusting the height of the printer 15.

Then, the CPU 111 reads out the passing timing of the object to be printed OB stored in the RAM 113, and causes the printer 15 to print the printing information in the printing region using thermochromic ink in accordance with the timing at which the printing region thereof passes through the printer 15 (ACT 22). That is, the CPU 111 reads out the first stored write information, and the setting ID and the printing position corresponding to the first stored write information, among the pieces of write information stored in the temporary storage unit 1131 of the RAM 113, and generates a code image of a two-dimensional code representing the read information and the current date and time tracked by a clock which is not shown. The CPU 111 also reads out, from the printing region table 1141 of the storage 114, a printing start position, a printing end position, a code printing start position, and a code printing end position corresponding to the setting ID. Then, the CPU 111 generates printing data used to print the character string of the write information and the code image based on the printing start position, the printing end position, the code printing start position, and the code printing end position. The CPU 111 supplies the generated printing data to the head drive circuit 117 and further supplies a printing execution instruction in accordance with the timing at which the printing region passes through the printer 15. After that, the CPU 111 deletes the read write information or the like from the temporary storage unit 1131. However, at this time, the height information having the code image printed therein is stored in the RAM 113 for the next reading operation. The head drive circuit 117 drives the printer head 151 of the printer 15 based on the supplied printing data in response to the printing execution instruction, and prints the printing information in the printing region. After that, the CPU 111 proceeds to the process of ACT 12.

In the case in which the CPU 111 is the multi-core or multi-threaded CPU, when determining that the previous printing operation is completed (ACT 20, YES), the CPU 111 may start the processes of ACT 21 and ACT 22 in parallel with the operation of this flowchart, and immediately proceed to the process of ACT 12.

When determining that the previous printing operation is not completed (ACT 20, NO), the CPU 111 determines whether or not previous reading operation is completed (ACT 23). The previous reading operation indicates reading operation for the object to be printed OB having a timing of arriving at the code reader 16 among the objects to be printed OB that are conveyed one after another. That is, it is required to set the code reader 16 at a height position corresponding to a printing region in each object to be printed OB, but the code reader 16 is not to be set at a height position corresponding to the next object to be printed OB before the reading operation for the object to be printed OB arriving thereat is completed. Therefore, in ACT 23, it is required to confirm the end of the reading operation.

When determining that the previous reading operation is completed (ACT 23, YES), the CPU 111 reads out, from the RAM 113, a printing region of a code image of the object to be printed OB that will arrive at the code reader 16 next, and drives the motor 18 for the code reader 16 by the motor drive circuit 118, thereby adjusting the height of the code reader 16 (ACT 24). Next, the CPU 111 reads out the passing timing of the object to be printed OB stored in the RAM 113, and causes the code reader 16 to read the code image in the printing information via the sensor circuit 116 in accordance with the timing at which the printing position thereof passes through the code reader 16 (ACT 25). The CPU 111 decodes the read code image to acquire the printing date and time and the write information such as a destination, associates the acquired information with a newly issued object ID, and stores the information associated therewith in the database 1142 of the storage 114 as object information (ACT 26). After that, the CPU 111 proceeds to the process of ACT 12.

In the case in which the CPU 111 is the multi-core or multi-threaded CPU, when determining that the previous reading operation is completed (ACT 23, YES), the CPU 111 may start the processes of ACT 24 to ACT 26 in parallel with the operation of this flowchart, and immediately proceed to the process of ACT 12.

When determining that the previous reading operation is not completed (ACT 23, NO), the CPU 111 proceeds to the process of ACT 12.

FIG. 13 is a diagram showing examples of printing on labels LA-S1, LA-S2, LA-S3, and LA-S4 having various sizes if the printing region is the label LA. In this manner, printing information can be accurately recorded on labels LA having various sizes, wherein the labels LA are printing regions of the objects to be printed OB that are conveyed one after another. A code image CD has a fixed size regardless of the printing area of the label LA, which is the printing region.

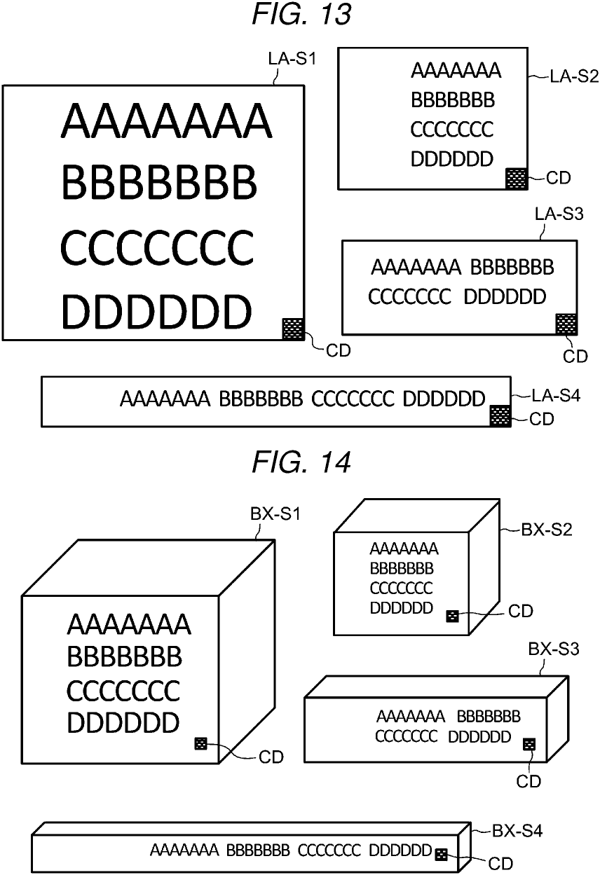

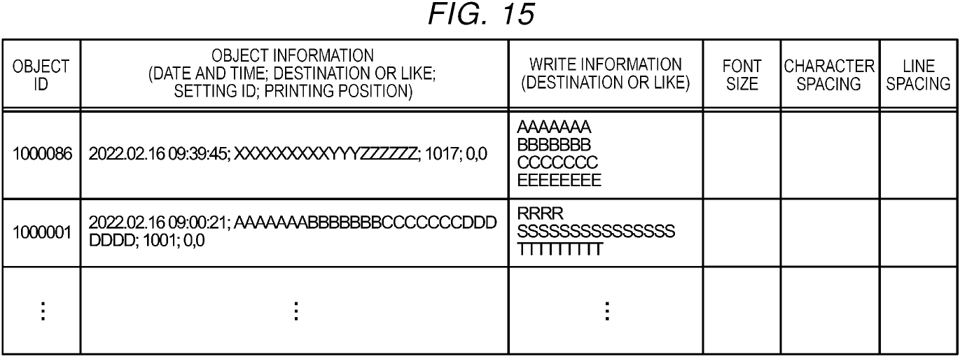

FIG. 14 is a diagram showing examples of printing on boxes BX-S1, BX-S2, BX-S3, and BX-S4 having various sizes if the printing region is one side surface of the box which is the object to be printed OB. In this manner, printing information can be accurately recorded on one side surfaces having various sizes, wherein the one side surfaces are printing regions of the objects to be printed OB that are conveyed one after another. A code image CD has a fixed size regardless of the printing area of one side surface, which is the printing region. Further, the printing information is printed thereon at a certain distance from an edge region of the box.

As described above, in the printing system 10 according to the embodiment, the CPU 111 serving as a control unit determines a printing region on an object to be printed OB being conveyed by the conveyance belt BE, wherein the printing region has any write information printed therein as printing information, determines whether the printing information having a specified character size can be printed in the printing region, and performs adjustment of a printing format of the printing information, the adjustment including at least changing the character size, so that the printing information can be printed in the printing region when determining that the printing information cannot be printed in the printing region. Then, the printer 15 prints the printing information having the adjusted printing format in the printing region of the object to be printed OB according to a timing at which the printing region of the object to be printed OB being conveyed by the conveyance belt BE passes through the printer 15.

As a result, it is possible to provide the printing system 10 capable of accurately recording printing information in printing regions of objects to be printed OB that are conveyed one after another.

Further, the printing system 10 according to the embodiment erases printing information printed in a printing region using thermochromic ink by allowing the heater 14 whose height position is adjusted depending on a printing region to apply heat from a direction perpendicular to a conveyance direction of an object to be printed OB according to a timing at which the printing region in the object to be printed OB being conveyed by the conveyance belt BE passes through the heater 14. The printing system 10 includes the printer 15 using thermochromic ink disposed in the rear stage of the heater 14 in the conveyance direction, and allows the printer 15 whose height position is adjusted depending on a printing region to print information on an object to be printed OB from a direction perpendicular to the conveyance direction according to a timing at which the printing region passes through the printer 15. The printing system 10 causes a printing surface including the printing region of the object to be printed OB to face the printer head 151 of the printer 15 at least at the time when the printer 15 prints the information thereon.

Accordingly, it is possible to provide the printing system 10 capable of accurately and efficiently rewriting and printing printing information in printing regions of objects to be printed OB that are conveyed one after another.

In the embodiment, the CPU 111 calculates a required area, which is a printing area required to be printed write information in a specified character size, and compares the required area with a printing area usable to be printed the write information in a printing region, thereby determining whether or not printing information can be printed.

Therefore, it is possible to easily determine whether the printing information can be printed.

The embodiment further includes the printing region table 1141, which is a storage unit configured to store a specified character size for each object to be printed.

Accordingly, a printing format of the printing information can be determined by starting from the maximum character size in advance depending on the object to be printed, thereby making it possible to determine the printing format more quickly than the case in which the printing format of the printing information is determined by starting from the same maximum character size regardless of the type of object to be printed.

In the embodiment, if the printing information cannot be printed in the printing region even after the character size is adjusted, the CPU 111 further changes character spacing, line feed, and line spacing in this order as the adjustment of the printing format.

Accordingly, by adjusting the printing format using a plurality of adjustment methods, it is possible to reduce the possibility of occurrence of a situation in which the printing information cannot be printed in the printing region. Further, the order of adjustment is set in the order of the character size, the character spacing, the line feed, and the line spacing, thereby making it possible to maintain the layout of the write information as much as possible.

In the embodiment, the printing system 10 includes the code reader 16 configured to read a code image representing information printed by the printer 15 from the object to be printed OB, and the database 1142 configured to record the information read by the code reader 16.

Accordingly, it is possible to perform various kinds of management including destination management with respect to the object to be printed OB, the printing of which is completed, using the information recorded in the database 1142.

In the embodiment, the code image is printed with a fixed printing size regardless of the size of the printing region.

Accordingly, regardless of the size of the printing region and the size of the write information, the code reader 16 can reliably read the code image.

In the embodiment, the printer head 151 of the printer 15 is provided in the direction perpendicular to the conveyance direction. Here, as a facing mechanism configured to cause the printing surface of the object to be printed OB to face the printer head 151, the printing system 10 includes the butt plate BP extending along the conveyance belt BE up to at least an installation position of the printer 15, wherein the butt plate BP is formed to rise from a surface on the conveyance belt BE side at a specified distance from the printer head 151, and a pressing mechanism disposed in the front stage of the installation position of the printer 15 in the conveyance direction, the pressing mechanism including the pressing plate PP configured to press the object to be printed OB against the butt plate BP.

Accordingly, it is possible to reliably cause the printing surface of the object to be printed OB to face the printer head 151.

In the embodiment, a timing at which a printing position passes through the heater 14 and the printer 15 is calculated based on the time when the timing sensor 12 detects the arrival of the object to be printed OB, wherein the timing sensor 12 is disposed in a front stage of the installation position of the heater 14 in the conveyance direction, and the pressing plate PP is disposed in a front stage of the timing sensor 12 in the conveyance direction.

Accordingly, the object to be printed OB can have the same posture if the same arrives at the timing sensor 12 and if the same arrives at the printer 15, thereby making it possible to prevent timing deviation.

### Second Embodiment

Next, a second embodiment will be described. Here, the description of the same configuration and operation as those of the first embodiment described above will be omitted. Hereinafter, portions different from those of the first embodiment will be described.

In the embodiment, a code reader is further added in the front stage of the heater 14 in the conveyance direction, thereby reading printing information printed on an object to be printed OB and specifying a printing region based on contents of the printing information.

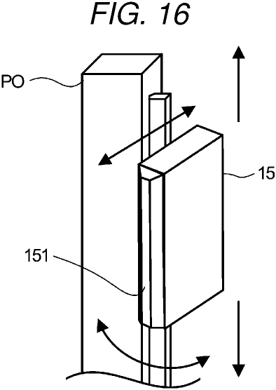

FIG. 15 is a diagram showing an example of information related to write information stored in the temporary storage unit 1131 of the RAM 113 in the second embodiment. In this manner, the write information is stored in association with an object ID and object information of the object to be printed OB stored in the database 1142 of the storage 114. That is, the printing information already printed on the object to be printed OB and the write information to be newly rewritten are associated with each other and stored in the temporary storage unit 1131. Accordingly, the CPU 111 can easily and accurately acquire the write information to be printed instead of the printing information being printed on the object to be printed OB. As a result, it is possible to eliminate restrictions that it is required to be conscious of the order in which printing is to be performed to store the same in the temporary storage unit 1131, and to place the objects to be printed OB on the conveyance belt BE in accordance with the order, thereby improving usability.

Since the code image includes the setting ID and the printing position, the CPU 111 can grasp the printing region without processing the image from the object sensor 13.

### Other Embodiments

Although each of the above-described embodiments shows an example in which the butt plate BP and the pressing plate PP are used as a facing mechanism configured to cause the printing surface of the object to be printed OB to face the printer head 151 of the printer 15 at least at the printing process position, the facing mechanism is not limited to such a configuration. FIG. 16 is a schematic diagram showing the position and posture adjustment operation of the printer 15 in order to cause the object to be printed to face the printer head 151.

For example, provided is an object sensor including a photoelectric sensor row disposed perpendicular to the conveyance belt BE and a photoelectric sensor row disposed horizontally with respect to the conveyance belt BE and perpendicular to the conveyance direction, the object sensor being configured to detect presence or absence of the object to be printed OB being conveyed by the conveyance belt BE. The CPU 111 can confirm the height of the object to be printed OB, that is, the height size of the printing surface, based on a detection result of the photoelectric sensor row of the object sensor disposed perpendicular to the conveyance belt BE. The CPU 111 can confirm a width of the object to be printed OB in the conveyance direction, that is, a width size of the printing surface, based on the detection result of the photoelectric sensor row and a conveyance speed of the conveyance belt BE. The CPU 111 can confirm a depth size of the object to be printed OB based on a detection result of the photoelectric sensor row of the object sensor disposed horizontally with respect to the conveyance belt BE and perpendicular to the conveyance direction.

If the object sensor as described above is used, it is possible to determine a placement position and a posture of the object to be printed OB diagonally placed on the conveyance belt BE, that is, what position the object to be printed OB is placed from an end portion on the printer 15 side of the conveyance belt BE, and what angle the object to be printed OB is diagonally placed thereon. Therefore, it is assumed that the facing mechanism is configured to be able to change not only a height position as shown by a solid arrow in FIG. 16, but also a direction or distance of the printer head 151 of the printer 15 with respect to the object to be printed OB as shown by a solid double-headed arrow in FIG. 16. In such a facing mechanism, the distance and the angle of the printer head 151 with respect to the object to be printed OB are adjusted depending on the determined placement position and posture of the object to be printed OB, thereby making it possible to cause the printing surface of the object to be printed OB to face the printer head 151 of the printer 15.

The order of processes shown in the flowcharts of FIGS. 10 to 12 is an example, and is not limited thereto. As long as there is no discrepancy occurring between the previous and subsequent processes, each process may be performed by changing the order thereof, or may be performed in parallel.

In adjusting the printing format, it may be possible to change a font to a character font in which a width size of one character is narrow even if the character size is the same.

In each of the embodiments, when calculating the passing timing at which the object to be printed OB passes through each process position in ACT 15, the conveyance speed of the object to be printed OB is calculated. However, if the CPU 111 controls the belt motor 19 by the motor drive circuit 118 so that the conveyance speed thereof becomes a predetermined constant speed, the calculation of the conveyance speed becomes unnecessary. In this case, since the distance from the timing sensor 12 to each process position does not change, a constant based on the movement speed and the distance is obtained and stored non-volatilely in the ROM 112 or the storage 114, thereby making it possible to simply calculate the passing timing of the object to be printed OB from the arrival timing of the timing sensor 12.

If the arrival at each process position is configured to be individually detected by a sensor, the operation timing of each process can be controlled independently, such that the arrangement position of the pressing plate PP in the first embodiment is not particularly limited. In this case, the pressing plate PP may be installed at a plurality of locations.

Since the code image is fixed to, for example, a size of 15 mm in length and width, it is not necessary to register both the code printing start position and the code printing end position in the printing region table 1141 of the storage 114. Here, either one may be registered therein and the other may be calculated by calculation.

In the first embodiment, if a camera is provided instead of the code reader 16 and contents of printing information are determined by character recognition, it may not be required to print a two-dimensional code as the printing information.

A conveyance machine configured to convey the object to be printed OB may have any configuration other than that of the conveyance belt BE, such as rollers consecutively disposed adjacent to each other.

Although each of the embodiments describes an example of a printing system configured to rewrite printing information in order to reuse an object to be printed OB on which printing information is already printed using thermochromic ink, it goes without saying that the printing system may be, for example, a printing system configured to rewrite printing information in order to reuse an object to be printed OB on which printing information is printed using a color-changing coloring material that is discolored due to a physical factor other than heat, such as discoloration due to ultraviolet rays, for example, a printing system configured to rewrite printing information in order to reuse an object to be printed OB on which printing information is printed using a color-changing coloring material other than ink, such as color-changing toner, and, for example, a printing system configured to perform one-time printing using general non-rewritable ink.

The functions described in each of the embodiments are not limited to being configured by using hardware, and can also be implemented by allowing a computer to read a program describing each function using software. Each function may be configured by appropriately selecting either software or hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printing system, comprising:
a conveyance machine configured to convey an object to be printed;
a controller configured to:
determine a printing region on the object to be printed being conveyed by the conveyance machine, the printing region provided to be printed with write information therein as printing information,
determine whether or not the printing information having a specified character size is printable in the printing region, and
perform adjustment of a printing format of the printing information, the adjustment including at least changing the character size, so that the printing information is printed in the printing region when determining that the printing information is not printable in the printing region; and
a printer configured to print the printing information having the adjusted printing format in the printing region of the object to be printed according to a timing at which the printing region of the object to be printed being conveyed by the conveyance machine passes through the printer.

2. The printing system according to claim 1, wherein the controller is further configured to:
calculate a required area, the required area being a printing area required to be printed with the write information having the specified character size in the printing region, and
compare the required area with a printing area usable to be printed with the write information in the printing region, thereby determining whether or not the printing information is printable.

3. The printing system according to claim 1, wherein the controller is further configured to:
change character spacing, line feed, and line spacing in this order as the adjustment of the printing format if the printing information is not printable in the printing region even after the character size is adjusted.

4. The printing system according to claim 1, wherein the printing information further includes a code image representing at least the write information, the code image having a fixed printing size regardless of a size of the printing region.

5. The printing system according to claim 1, wherein the printer prints the printing information having the adjusted printing format in the printing region of the object to be printed using a color-changing coloring material.

6. The printing system according to claim 1, wherein the controller is further configured to:
change at least one of character spacing, line feed, and line spacing as the adjustment of the printing format if the printing information is not printable in the printing region even after the character size is adjusted.

7. The printing system according to claim 1, wherein the controller is further configured to:
determine whether or not the printing information having a specified aspect ratio is printable in the printing region, and
perform adjustment of a printing format of the printing information, the adjustment including at least changing the aspect ratio, so that the printing information is printed in the printing region when determining that the printing information is not printable in the printing region.

8. A printing method, comprising:
conveying an object to be printed;
determining a printing region on the object to be printed being conveyed, the printing region provided to be printed with write information therein as printing information;
determining whether or not the printing information having a specified character size is printable in the printing region;
adjusting a printing format of the printing information, adjusting including at least changing the character size, so that the printing information is printed in the printing region when determining that the printing information is not printable in the printing region; and
printing the printing information having the adjusted printing format in the printing region of the object to be printed according to a timing at which the printing region of the object to be printed being conveyed passes through a printer.

9. The printing method according to claim 8, further comprising:
calculating a required area, the required area being a printing area required to be printed with the write information having the specified character size in the printing region; and
comparing the required area with a printing area usable to be printed with the write information in the printing region, thereby determining whether or not the printing information is printable.

10. The printing method according to claim 8, further comprising:
changing character spacing, line feed, and line spacing in this order as the adjustment of the printing format if the printing information is not printable in the printing region even after the character size is adjusted.

11. The printing method according to claim 8, further comprising:
printing the printing information having the adjusted printing format in the printing region of the object to be printed using a color-changing coloring material.

12. The printing method according to claim 8, further comprising:
changing at least one of character spacing, line feed, and line spacing as the adjustment of the printing format if the printing information is not printable in the printing region even after the character size is adjusted.

13. The printing method according to claim 8, further comprising:
determining whether or not the printing information having a specified aspect ratio is printable in the printing region; and
adjusting a printing format of the printing information, the adjustment including at least changing the aspect ratio, so that the printing information is printed in the printing region when determining that the printing information is not printable in the printing region.

14. A label printer, comprising:
a conveyance machine configured to convey a label to be printed;
a controller configured to:
determine a printing region on the label to be printed being conveyed by the conveyance machine, the printing region provided to be printed with write information therein as printing information,
determine whether or not the printing information having a specified character size is printable in the printing region, and
perform adjustment of a printing format of the printing information, the adjustment including at least changing the character size, so that the printing information is printed in the printing region when determining that the printing information is not printable in the printing region; and
an inkjet printer configured to print the printing information having the adjusted printing format in the printing region of the label to be printed according to a timing at which the printing region of the label to be printed being conveyed by the conveyance machine passes through the inkjet printer.

15. The label printer according to claim 14, wherein the controller is further configured to:
calculate a required area, the required area being a printing area required to be printed with the write information having the specified character size in the printing region, and
compare the required area with a printing area usable to be printed with the write information in the printing region, thereby determining whether or not the printing information is printable.

16. The label printer according to claim 14, wherein the controller is further configured to:
change character spacing, line feed, and line spacing in this order as the adjustment of the printing format if the printing information is not printable in the printing region even after the character size is adjusted.

17. The label printer according to claim 14, wherein the printing information further includes a code image representing at least the write information, the code image having a fixed printing size regardless of a size of the printing region.

18. The label printer according to claim 14, wherein the inkjet printer prints the printing information having the adjusted printing format in the printing region of the label to be printed using a color-changing coloring material.

19. The label printer according to claim 14, wherein the controller is further configured to:
change at least one of character spacing, line feed, and line spacing as the adjustment of the printing format if the printing information is not printable in the printing region even after the character size is adjusted.

20. The label printer according to claim 14, wherein the controller is further configured to:
determine whether or not the printing information having a specified aspect ratio is printable in the printing region, and
perform adjustment of a printing format of the printing information, the adjustment including at least changing the aspect ratio, so that the printing information is printed in the printing region when determining that the printing information is not printable in the printing region.
